(19) United States
(12) Patent Application Publication
(10) Pub. No.: US 2006/0086227 A1
(43) Pub. Date: Apr. 27, 2006

(54) Cutterhead

(76) Inventor: Fumio Shimizu, Tokyo (JP)

Correspondence Address: Michael S. Leonard;Everest Intellectual Property Law Group, P.O. Box 708, Northbrook, IL, 60065, US

(21) Appl. No.: 11/247,037

(22) Filed: Oct. 11, 2005

(30) Foreign Application Priority Data
Oct. 25, 2004 (JP) 2004-309818

(51) Int. Cl. B26D 1/00

(52) U.S. Cl. 83/651

(57) ABSTRACT

This invention provides a cutterhead attached to a slider disposed on a rail, and composed of an attachment/detachment part of a cutter holder, a cutter cover attachable to and detachable from the cutter holder, a cutter lever, and the like, the cutter holder being urged by a cutter spring to the slider, and the cutter lever and the cutter cover being able to be detachably attached thereto, a side surface of a rotary blade being supported by an arc-shaped cutter abutting plate, and an escape surface for removing cut pieces produced by cutting by the rotary blade being formed on an arc-shaped peripheral surface of the cutter abutting plate, so that a cutting blade is reliably held in a stable excellent state and cutting work of the cutting blade is not obstructed by cut pieces produced by cutting by the cutting blade.

### BACKGROUND OF THE INVENTION

1. Field of the Invention

The present invention relates to a cutterhead mounted to a slider, which slides along a paper holding ruler in a paper cutter.

2. Description of the Related Art

As a conventionally employed paper cutter of a form in which a slider is slid along a paper holding ruler, there are a paper cutter (for example, see Japanese Patent Laid-Open Publication No. 6-262586) that the present applicant has previously proposed, a paper cutter (for example, see Japanese Patent Laid-Open Publication No. 10-34592), and the like.

As shown in FIG. 14, in the paper cutter described in Japanese Patent Laid-Open Publication No. 6-262586, a rail 70 which extends in a vertical direction with respect to the plane of this drawing is urged upward through springs (not shown) in the vicinity of both ends of the rail, and both ends of the rail 70 are supported so as to be able to move up and down by means of a support member (not shown). That is, the rail 70 is supported by means of the springs (not shown) in a floating state.

The slider 72, which is slidable along the rail 70 is fitted into the rail 70 through a guiding member 78. Holding members 75 formed of a sponge or the like for holding a paper to be cut are disposed on the bottom surface of the rail 70. The rail 70 also serves as a paper holding ruler.

A rotary blade 73 is rotatably supported on a shaft 79, which is fitted into a slide bearing 80. Both ends of the shaft 79 are respectively supported rotatably by a bearing 82 provided in a slider main body side and a bearing 83 provided on a cover 81 which is detachably attached to the slider main body. In a state where the guiding member 78 is fitted into the rail 70, a side surface of the rotary blade 73 is in a state where it is in contact with a positioning surface 74 of the rail 70.

Positioning piece 76 for positioning paper to be cut is formed on both end portions of a base 71. Further, a movable positioning piece 77 for positioning the rear end of the paper to be cut is disposed on the base 71.

The paper to be cut whose side edges are positioned by the positioning pieces 76 is inserted between the bottom surface of the rail 70 and the base 71, and the rear end of the paper to be cut is positioned by the movable positioning piece 77, so that the paper to be cut can be set at a cutting position.

By moving the slider 72 along the rail 70 while the slider is pressed down, with the movement of the slider 72, the rail 70 can freely move upward and downward by a balance of forces among three parties of the urging force of the springs (not shown), the rigidity force of the rail 70, and the pressing force of the slider 72. Thus, even when the slider 72 is moved in order to cut paper, the paper to be cut can be sandwiched between the rail 70 and the base 71, and the paper to be cut can be cut at the cutting position by means of the rotary blade 73 mounted to the slider 72.

As shown in FIGS. 15 and 16, in the paper cutter described in Japanese Patent Laid-Open Publication No. 10-34592, a guiding rail 90 is supported between distal ends of a pair of arms which are mounted raisably/lowerably on both end portions of a base plate (not shown). A cutterhead 91 is movably attached to the guiding rail 90.

The cutterhead 91 is composed of a head main body 93 having a handle 92, which is curved on an upper part of the head main body 93, a rotary blade 94, and a cap 95. As shown in FIG. 16, the head main body 93 is fitted into the guiding rail 90. A spring 96 such as a leaf spring or the like is provided in a lower part of the head main body 93, so as to urge the head main body 93 upward with respect to the guiding rail 90 when any external force is not applied to the head main body 93.

A central part of a disk-like blade main body 97 in the rotary blade 94 is mounted by means of a resin knob 98. The rotary blade 94 is sandwiched between a disk 99 formed on a cylindrical portion 100 of the knob 98 and a member 101 provided with an elastic claw 102. The cylindrical portion 100 is fitted into a circular recess portion of the head main body 93, and the member 101 is fitted into a circular recess portion of the cap 95 so that the rotary blade 94 is rotatably supported.

The cap 95 is coupled and secured to the head main body 93 by means of a bayonet coupling. That is, an engaging groove provided with the same cross-sectional shape as that of an engaging protrusion formed on the head main body 93 is formed on the cap. After the engaging protrusion and the engaging groove are engaged with each other, by screwing the cap 95 only a little angle, the cap 95 can be fixed on the head main body 93.

After paper to be cut is placed on the base plate (not shown), the guiding rail 90 is pressed to a position where it is in intimate contact with the paper surface, and then while being pressed by a hand, the handle 92 of the cutterhead 91 is moved along the guiding rail 90. Thus, the paper to be cut can be cut by the rotary blade 94 mounted in the cutterhead 91.

At this time, by the pressing force applied to the cutterhead 91, the guiding rail 3 is pressed downward through the spring 96. The cutterhead 91 moves downward while allowing the spring 96 to be bent relatively with respect to the guiding rail 90. The rotary blade 94 protrudes from the bottom surface of the guiding rail 90 to rotate while cutting into the surface of the paper to be cut, thereby cutting the paper to be cut.

In the paper cutter described in Japanese Patent Laid-Open Publication No. 6-262586, the lower surface in the cover 81 which faces the base 71 side is a surface parallel to the base 71. With this situation, the maximum number of paper sheets to be cut that the rotary blade 73 can cut corresponds to the number of paper sheets, which can exist between the distal edge of the rotary blade 73 and the lower surface of the cover 81. That is, when the lower surface abuts cut pieces obtained by cutting by means of the rotary blade 73 during cutting, the lowering of the slider 72 is restricted, and further cutting by means of the rotary blade 73 cannot be performed.

Moreover, when the lower surface of the cover 81 abuts the paper to be cut at a cut starting time by means of the rotary blade 73, a situation that a cutting/placement position of paper to be cut is shifted occurs. Particularly, in the paper cutter described in Japanese Patent Laid-Open Publication No. 6-262586, the holding force of pressing and holding paper to be cut is given by the pressing force of pressing the slider 72.

Thus, when the slider 72 is slid so that the lower surface of the cover 81 abuts paper to be cut, sliding of the slider 72 may be obstructed, or a force for lifting the slider 72 upward may be generated by the abutting. At this time, if the pressing force of pressing the slider 72 is weakened, or if the hand force of pressing the slider 72 is weakened, the force of pressing and holding paper to be cut is decreased.

When the slider 72 further slides in a state where the force of pressing and holding paper to be cut is decreased, the cut position of paper to be cut is shifted by the lower surface of the cover 81 or a portion adjacent thereto as the slider 72 slides. Furthermore, since cutting by means of the rotary blade is performed while paper to be cut is shifted, cut paper-may be zigzag-shaped, and cutting is not performed precisely.

Even in the paper cutter described in Japanese Patent Laid-Open Publication No. 10-34592, the spring 96 is compressed by the force of pressing the cutterhead 91, and the force of pressing paper to be cut is imparted to the guiding rail 90 through the compressed spring 96. Thus, similarly to the case of Japanese Patent Laid-Open Publication No. 6-262586, when the lower surface which faces the base plate side of the cap 95 abuts paper to be cut placed on the base plate, further cutting by means of the rotary blade 94 cannot be performed.

When the lower surface of the cap 95 or a portion adjacent thereto abuts paper to be cut, a situation such that a cutting/placement position of paper to be cut is shifted occurs, whereby there is a problem similar to that in Japanese Patent Laid-Open Publication No. 6-262586.

The present invention is to solve the above-described problems, and it is an object of the present invention to provide a new cutterhead in a paper cutter in which a paper holding function in a stable, excellent state is reliably ensured and in which cutting work of a cutting blade is not obstructed by cut pieces produced by cutting by means of the cutting blade.

### SUMMARY OF THE INVENTION

The above-described object is achieved by a cutterhead attached to a slider which is slidable along a paper pressing plate in a paper cutter, being characterized in that the cutterhead comprises a cutter abutting plate supporting one side surface of a cutting blade, and that an escape surface for removing cut pieces produced by cutting of paper to be cut from the cutting blade side is formed on at least one part of an end portion in the cutter abutting plate facing a base side of the paper cutter.

Consequently, cut pieces produced by cutting by means of the cutting blade can be removed in a direction in which cut pieces are separated from a cutting blade side by means of the escape surface. As the cutting blade, a rotary blade, or a fixed blade provided with a linear or curvilinear warp can be employed.

Thus, a situation in which a large amount of cut pieces are in contact with the cut-pieces-side surface of the cutting blade, that is, the side surface supported by the cutter abutting plate, can be avoided, and cutting work by means of the cutting blade can be performed constantly and stably. Even when the lower end surface of the cutter abutting plate abuts upper surfaces of cut pieces, since the abutted cut pieces are removed by means of the escape surface formed on the lower end surface of the cutter abutting plate, the cutting blade can move further in the thickness direction of stacked paper to be cut.

Thus, even paper to be cut which are stacked more than a thickness corresponding to a length from the bottom end of the cutter abutting plate to the blade edge of the cutting blade can be cut precisely to the final sheet by means of the cutting blade.

As the paper pressing plate of the present invention, a form in which one end portion of the paper pressing plate is a rotation fulcrum or a form in which both ends of the paper pressing plate are attached to a paired rotation arms so that the paper pressing plate rotates about base ends of the pair of arms as described in Japanese Patent Laid-Open Publication No. 10-34592 may be employed.

Also, as the paper pressing plate of the present invention, a form that the paper pressing plate moves up and down while constantly maintaining a normal state with respect to the base surface, or a form that the paper pressing plate is supported in a floating state with respect to the base as described in Japanese Patent Laid-Open Publication No. 6-262586, or other appropriate forms, may be employed.

Particularly, by applying the cutterhead of the present invention to a type in which the paper pressing plate moves up and down while constantly maintaining a normal state with respect to the base surface, since the paper pressing plate can be fixed at a predetermined position in accordance with the number of paper sheets to be cut, a sliding height position of the slider which slides along the paper pressing plate can be at a certain height position.

Thus, only by allowing the slider to slide in a horizontal direction along the paper pressing plate, a desired number of paper sheets to be cut can be cut successively and smoothly. Further, the cutting position of the cutting blade is automatically controlled by means of the spring force of the spring which presses the cutterhead toward the base side, and the blade edge position of the cutting blade can be successively lowered while cut pieces are removed by means of the escape surface of the cutter abutting plate. At this time, since the slider is only allowed to slide along the paper pressing plate, cutting by means of the cutting blade can be performed lightly.

In the present invention, the slider and the cutterhead are described as a separate member. However, since a head main body as described in Japanese Patent Laid-Open Publication No. 10-34592 can be expressed as a slider and since a knob and a cap can be expressed as a cutterhead, one that treats a member having a slider function as a slider of the present invention and that treats a member having a holding function of the cutting blade as the cutterhead of the present invention, and these two can be included in the concept of the slider and the cutterhead of the present invention.

Although there is a paper cutter in which a paper pressing plate and a guiding rail on which a slider slides have separate structures, both a paper pressing plate and a guiding rail having a separate structure independent of the paper pressing plate are constructed as the paper pressing ruler.

Preferably, at least at a cut-starting time of paper to be cut by means of the cutting blade, the cutting blade is sandwiched by the cutter abutting plate and a side surface of the paper pressing plate.

Consequently, the cutting blade can be held in a stable state constantly. Thus, the cutting blade can cut paper while maintaining a state where the blade edge is straight without being blurred during cutting, so that paper to be cut can be cut constantly along a straight cutting line.

Further, even when the lower surface of the cutter abutting plate abuts the paper to be cut at the starting time of cutting by means of the cutting blade, an adverse influence due to the abutting of the cutter abutting plate and the paper to be cut can be reduced by the escape surface.

Preferably, the cutting blade is a rotary blade, and the cutterhead rotatably supports the rotary blade.

Consequently, the rotary blade rotates before the cutter abutting plate abuts the paper to be cut, and pressing the paper to be cut by means of the cutter abutting plate can be avoided.

Preferably, the cutterhead is attached to the slider through a spring which urges the cutterhead toward the base side of the paper cutter.

Consequently, the escape surface formed on the lower surface of the cutter abutting plate abuts the paper to be cut, and the cutterhead can escape in a direction in which the spring urging the cutterhead is compressed by avoidance due to_the rotation of the rotary blade and the escape surface.

At this time, the cutterhead can escape in the direction in which the cutterhead is separated from the base independently from the slider. Thus, even if the paper pressing plate is pressed by the pressing force of the slider so that paper to be cut is pressed and held by the same pressing force, the pressing force from the slider which presses the paper pressing plate does not change, and the paper pressing plate can be constantly pressed with the same pressing force.

As described already, when a rotary blade is employed as the cutting blade, other than the effects described above, when a cutting force by the rotary blade is increased, the rotary blade rotates so that an abnormal increase of the cutting force can be avoided. At this time, by the structure that the cutterhead is attached to the slider through a spring which urges the cutterhead toward the base side of the paper cutter, the cutterhead even can move in the direction in which the cutterhead is separated from the paper to be cut to avoid abnormal increase in the cutting force. By employing both structures, the effect by the rotary blade and the effect by the spring pressing the cutterhead can be synergistically multiplied. Thus, the effects which the present invention exerts are very remarkable.

### BRIEF DESCRIPTION OF THE DRAWINGS

FIG. 1 is a perspective view of an entire paper cutter according to the present invention (Embodiment);

FIG. 2 is a cross-sectional view of a main part, taken along line II-II of FIG. 1, in a state where holding means is opened (Embodiment 1);

FIG. 3 is a back surface view of a main part of a slider and a rail (Embodiment 1);

FIG. 4 is a cross-sectional view of a main part of a slider and a rail, taken along line IV-IV of FIG. 3 (Embodiment 1);

FIG. 5 is a view showing a relationship between a cutter cover and a cutter lever (Embodiment 1);

FIG. 6 is a view showing a rotating state of the cutter lever (Embodiment 1);

FIG. 7 is a back surface view of FIG. 6 (Embodiment 1);

FIG. 8 is a first view explaining a cutting state of a rotary blade (Embodiment 1);

FIG. 9 is a second view explaining a cutting state of the rotary blade (Embodiment 1);

FIG. 10 is a third view explaining a cutting state of the rotary blade (Embodiment 1);

FIG. 11 is a fourth view explaining a cutting state of the rotary blade (Embodiment 1);

FIG. 12 is a first view comparing the cutting states of the rotary blade (Conventional example);

FIG. 13 is a second view comparing cutting states of the rotary blade (Conventional example);

FIG. 14 is a vertical cross-sectional view of a rotary blade portion of a slider (Conventional example 1);

FIG. 15 is a perspective view of a cutterhead (Conventional example 2); and

FIG. 16 is a cross-sectional view of the cutterhead (Conventional example 2).

### DESCRIPTION OF THE PREFERRED EMBODIMENTS

Preferred embodiments of the present invention will be described below in a specific manner with reference to the accompanying drawings. With respect to a structure of a cutterhead of the present invention, even when it is other than a shape and arrangement described below, as long as it is a shape and arrangement through which the problem of the present invention can be solved, it can be adopted as a cutterhead in a paper cutter. Thus, the present invention is not limited to embodiments described below, and various changes can be made.

First, a structure of a paper cutter provided with a cutterhead according to the present invention will be described, and then the cutterhead will be described. The structure of a paper cutter described below is merely an example, and as long as a paper cutter is provided with a slider, a cutterhead of the present invention can be applied to another type of paper cutter.

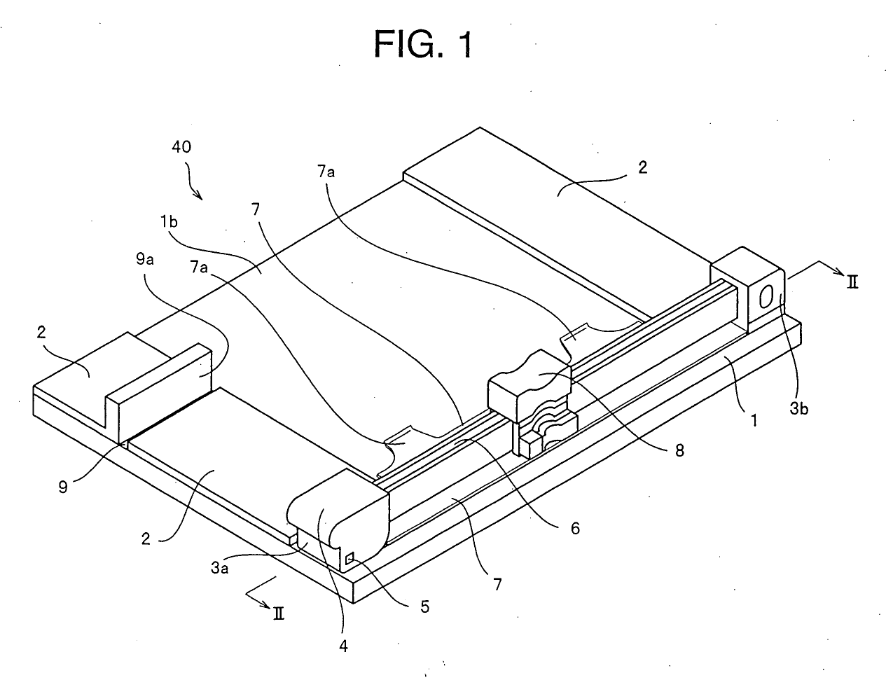

The paper cutter 40 shown in FIG. 1 is provided with a rectangular base 1 having a base surface 1b on which paper to be cut is placed, a paper pressing plate 7 which positions paper to be cut on the base surface 1b of the base 1 to press and hold it, a rail 6 which is supported separably and contactably with respect to the base surface 1b, and a slider 8 which moves along the rail 6 and to which a cutting blade is attached to cut paper to be cut to a required size. In the embodiment, a paper-pressing ruler is composed of the paper pressing plate 7 and the rail 6. With respect to the base surface 1b, restricting pieces 2 for restricting side edges of the paper to be cut are provided both on the left and right ends thereof.

A pad (not shown) made of a rubber material or other materials having a high friction coefficient is allowed to adhere integrally on the lower surface of the base surface 1b which abuts the paper pressing plate 7 by means of an appropriate fixing means so that the cutter can be reliably held on a fixed position.

A fitting recess having a narrow width, extending to both side ends of the base 1 in a longitudinal direction thereof, is extended linearly on the base surface 1b which is adjacent to the pad. A slender blade rest pad made from a hard rubber material or the like is fitted into the fitting recess to be supported thereby, and the installation portion of the fitting recess corresponds to the cutting position of a rotary blade (not shown) which is mounted to the slider 8.

Although an example employing a rotary blade as a cutting blade will be described, the present invention is not limited to the rotary blade, and a fixed blade having a linear or curvilinear warp can be employed.

Both ends of the rail 6 are supported by means of supporting bodies 3a, 3b. Movement of the rail 6 in a direction parallel to the base surface 1b is restricted, and the rail 6 is movably supported in a direction perpendicular to the base surface 1b. A holding means 4, which allows the rail 6 to move in a direction perpendicular to the base surface 1b is disposed on the supporting body 3a.

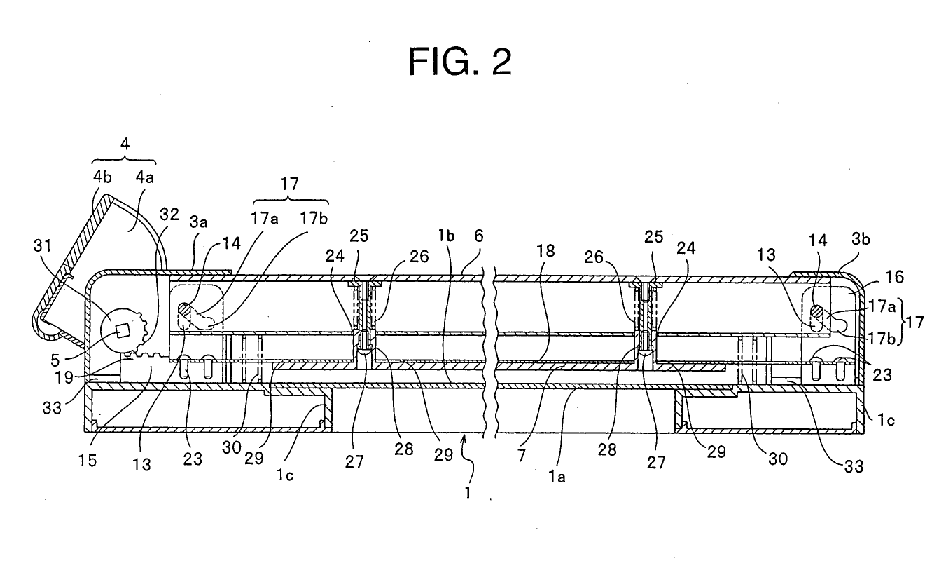

The paper pressing plate 7 is rotatably supported on the rail 6 through paper pressing springs (see reference numeral 26 in FIG. 2) and can move together with the movement of the rail 6 in the same direction as that of the rail 6.

At least one or more guiding wings 7a are integrally formed in the paper insertion side of the paper pressing plate 7, and an end portion of the guiding wing 7a is opened in a direction in which it is gradually separated from the base surface 1b in order to allow paper to be cut to be easily inserted.

As the end portion of the guiding wing 7a, an upward curl shape, an inclined surface of upward inclining toward the end portion of the guiding wing 7a, and the like are formed. By this, a large number of paper sheets to be cut are easily inserted into a gap between the paper pressing plate 7 and the base surface 1b, and furthermore an insertion state can be recognized easily. Particularly, by forming the paper pressing plate 7 from a transparent or semitransparent material, the insertion state can be confirmed easily.

A regulation groove 9 having approximately the same gap as that between the paper pressing plate 7 and the base surface 1b and a guiding wall 9a extending from one surface of the regulation groove 9 are formed on the restricting piece 2. A large number of paper sheets to be cut, before being inserted into the gap between the paper pressing plate 7 and the base surface 1b, can be inserted into the regulation groove 9 so that whether the number of paper sheets is an insertable one or not can be confirmed. When they can be inserted into the regulation groove 9, it can be confirmed in advance that the same number of paper sheets to be cut can be easily inserted into the gap between the paper pressing plate 7 and the base surface 1b.

The guiding wall 9a functions as a guiding surface of when a large number of paper sheets to be cut are inserted into the regulation groove 9, and can prevent a large number of paper sheets to be cut, which have been inserted into the regulation groove 9 from bending and falling down.

In FIG. 1, a movable restricting piece restricting the rear end portion of paper to be cut, a guiding groove which allows this restricting piece to slide and to be guided, and the like are not illustrated. However, a structure that this movable restricting piece is provided or that ruler lines are drawn on the base surface 1b is one of various structures provided in the conventional paper cutters, and such structures can be adopted properly as the need arises.

Next, operating mechanism of the rail 6 and the paper pressing plate 7 will be described with reference to FIG. 2. FIG. 2 is a cross-sectional view in which the slider 8 is omitted, taken along line II-II of FIG. 1, showing a state where the holding means 4 rotates together with a handle shaft 5. As shown in FIG. 2, the pair of supporting bodies 3a, 3b are fixed on the base 1, and first guiding holes 13 extending in a direction perpendicular to the base surface 1b are formed on side surfaces of the supporting bodies 3a, 3b.

Both ends of the rail 6 are respectively supported on the first guiding holes 13 through coupling pins 14, and the rail 6 is supported so as to be movable in the vertical direction with respect to the base surface 1b, along the first guiding hole 13. A push-up spring 30 is arranged between the rail 6 and the base surface 1b. The rail 6 is urged by means of the push-up spring 30 in a direction in which the rail 6 is separated from the base surface 1b.

The paper pressing plate 7 is disposed between the rail 6 and the base surface 1b. A guide pin 25 is fixed in the rear surface side of the rail 6, and a guiding cylinder 28 protruding from the paper pressing plate 7 is slidably disposed so that the guide pin 25 is a guiding surface. A paper pressing spring 26 is disposed between the rear surface side of the rail 6 and the guiding cylinder 28. The sliding amount of the guiding cylinder 28 is defined by a stopper screw 27 screwed into the guide pin 25 and a stepped portion formed on the inner surface of the guiding cylinder 28.

By sliding of the guiding cylinder 28 along the guide pin 25, the paper pressing plate 7 can move in a separating/approaching direction with respect to the base surface 1b with being independent of the rail 6. Since the guiding cylinder 28 is allowed to slide along the guide pin 25, in the rail 6, an aperture 24 is formed around the guide pin 25 in order to prevent interference with the guiding cylinder 28.

An interlock member is disposed between the rail 6 and the paper pressing plate 7. The interlock member has a structure in which an arm 18 is attached between a pair of cam members 15, 16, and has a mechanism that the rail 6 is moved up and down while the parallel state of the rail 6 is maintained. The arm 18 is fixed on the cam members 15, 16 by means of fixing screws 23.

Second guiding holes 17 directed in the same direction are respectively formed on the side walls of the cam members 15, 16, and the second guiding hole is composed of an inclined guiding surface 17a and a parallel guiding surface 17b which is continuous to the inclined guiding surface 17a.

An oblong hole 29 is formed in the longitudinal direction of the arm 18 to prevent the interference between the guiding cylinder 28 and the push-up spring 30 which urges the rail 6 in a direction in which the rail 6 is pushed up, by the movement of the arm 18. Guiding recesses (not shown) formed on the bottom surface sides of the cam members 15, 16 are arranged across guiding rails 33 formed on the base surface 1b inside the supporting bodies 3a, 3b, and sliding guide can be performed in a left-and-right direction of FIG. 2 using these guiding rails 33 as guiding surfaces.

Coupling pins which support both ends of the rail 6 respectively are inserted into the second guiding holes 17 of the interlock member and the first guiding holes 13 of the supporting bodies 3a, 3b. By the movement of the interlock member in the direction parallel to the base surface 1b, the rail 6 can move in the direction perpendicular to the base surface while constantly maintaining a parallel state with respect to the base surface.

The holding means 4, which allows the interlock member to move in the direction parallel to the base surface 1b is rotatably supported on the supporting body 3a. The handle shaft 5 is non-rotatably attached to the holding means 4. A pinion 31 engaging a rack portion 19 of the cam member 15 is disposed on the handle shaft 5 while rotation thereof with respect to the handle shaft 5 is restricted.

The handle shaft 5 is rotatably supported in the supporting body 3a through a bearing or the like. A rotation motion by the holding means 4 can be converted into a straight-line motion of the interlock member by means of the rack portion 19 and pinion 31.

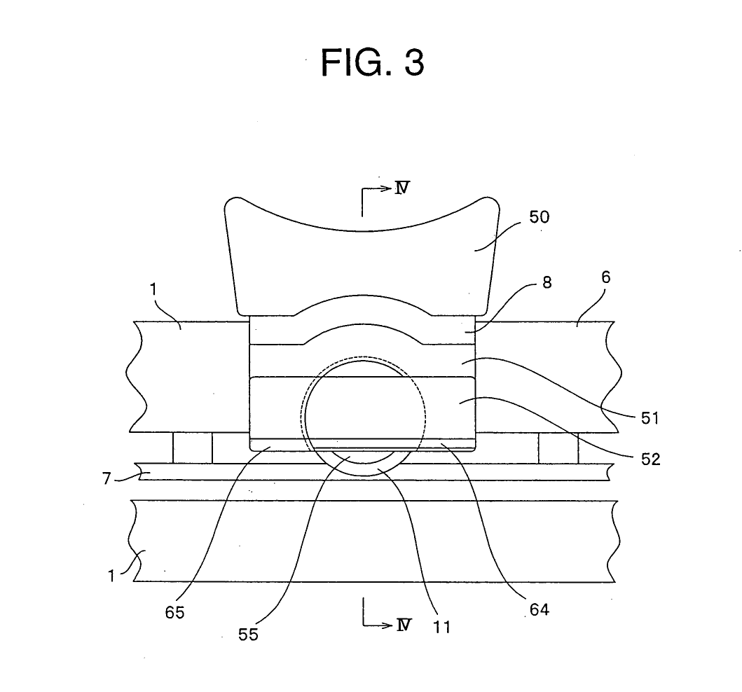

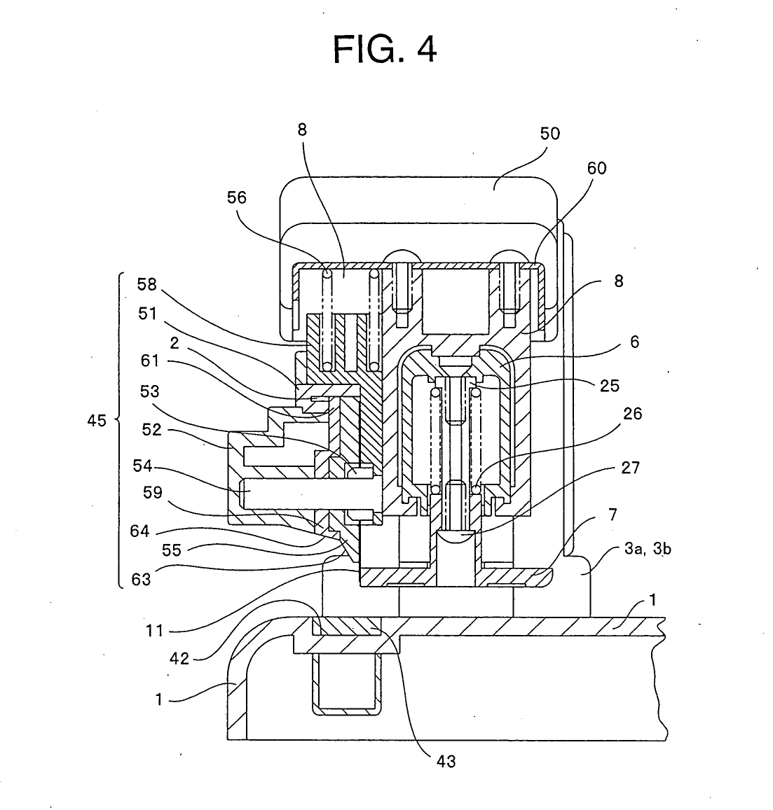

Next, a structure of a cutterhead 45, attachment of a rotary blade 11 to the cutterhead 45, and mounting of the cutterhead 45 to the slider 8 will be described with reference to FIGS. 3 through 6. FIG. 3 is a back surface view of the main part of the slider 8 and the rail 6. That is, it is a view seen from the rear surface of the paper cutter in FIG. 1. FIG. 4 shows a cross-sectional view, taken along line IV-IV of FIG. 3.

As shown in FIGS. 3 and 4, a slider cover 50 for satisfactory making contact with a hand of operating the slider 8 is provided on the slider 8 arranged on the rail 6. The cutterhead 45 is mounted to the slider 8.

The cutterhead 45 is composed of an attachment/detachment part of a cutter holder 58, a cutter cover 51 which is attachable/detachable to/from the cutter holder 58, a cutter lever 52 and the like. A guiding groove (not shown) for allowing the cutter holder 58 to be guided to slide in upward and downward directions of FIG. 4 is formed in the slider 8, and an engagement guiding piece (not shown) which is fitted into the guiding groove is formed on the cutter holder 58.

A cutter spring 56 is disposed between the cutter holder 58 and the slider 8. The cutter holder 58 is urged in the base 1 direction by means of the cutter spring 56. Also, a stopper (not shown) restricting a lowered position of the cutter holder 58 is formed between the cutter holder 58 and the slider 8.

The attachment/detachment part which is attachable/detachable to/from the cutter holder 58 is composed of a cutter lever 52, the cutter cover 51, an engaging member 59, a cutter abutting plate 55, and a cutter shaft 54. The cutter lever 52, which rotatably supports the rotary blade 11 is provided with the engaging member 59 and the cutter abutting plate 55.

The cutter lever 52 is rotatably attached to the cutter cover 51. The cutter shaft 54 is attached to the cutter lever 52, penetrating the cutter lever 52, the engaging member 59, and the cutter abutting plate 55.

The cutter shaft 54 is rotatably fitted into a fitting bush 53, and the rotary blade 11 is mounted to the fitting bush 53. Although the fitting bush 53 is illustrated as a hexagonal bush in FIG. 7 that is the back surface view of the attachment/detachment part, the cross-sectional shape of the fitting bush 53 is not limited to a hexagon, and bushes of other cross-sectional shapes may be employed as long as the bush has a shape through which the shaft hole of the rotary blade 11 can be supported. The rotary blade 11 may be rotatably mounted to the fitting bush instead of rotatable fitting of the cutter shaft 54 into the fitting bush 53.

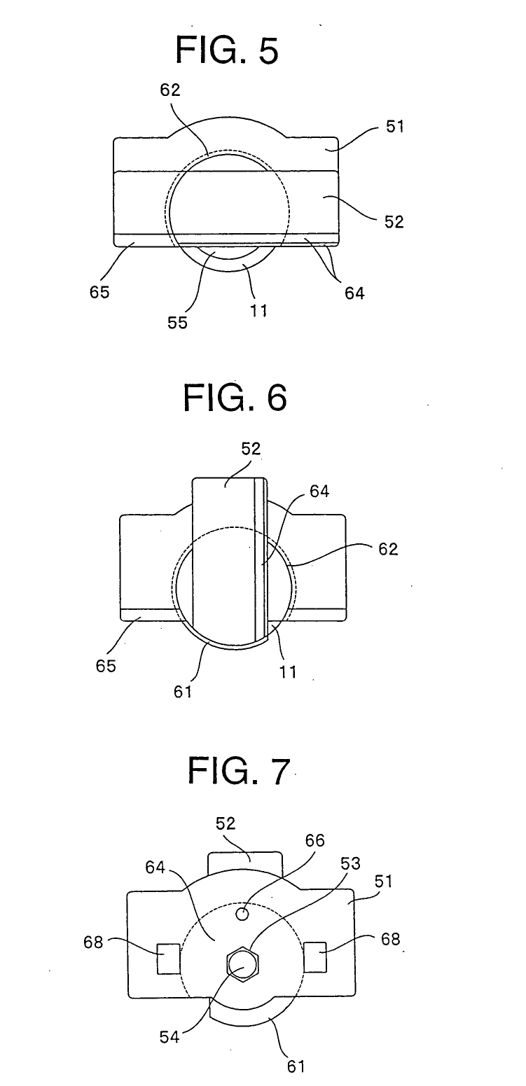

As shown in FIGS. 5 and 6, the cutter lever 52 can be rotated with respect to the cutter cover 51. FIG. 6 shows a state where the cutter lever 52 is rotated 90 degree in a counterclockwise direction with respect to the cutter cover 51. FIG. 7 shows the back surface view of FIG. 6. When the cutter lever 52 is rotated 90 degree in the counterclockwise direction with respect to the cutter cover 51 from the state of FIG. 5 as shown in FIG. 6, fitting holes 68 for fixing the attachment/detachment part to the cutter holder 58 can be opened in the cutter cover 51 as shown in FIG. 7. A member 66 in FIG. 7 is a magnet, which can hold a rotary blade.

With respect to the fitting holes 68, when the cutter lever 52 is returned to the state of FIG. 5, a flange portion 61 formed on an end portion of the engaging member 59 can be allowed to protrude into the inside of the fitting holes 68. The protruded flange portion 61 is engaged an engaging groove (not shown) formed on the cutter holder 58 so that the attachment/detachment part can be attached to the cutter holder 58. The flange portion 61 is formed as a folding fan shape on an end portion of the engaging member 59 and is symmetrically formed on a region whose centerline extends vertically, passing through the centerline of rotation of the engaging member 59.

As shown in FIG. 4, a side surface of the rotary blade 11 attached to the fitting bush 53 is supported by the arc-shaped cutter abutting plate 55. An escape surface 63 for removing cut pieces, which have been cut by means of the rotary blade 11 is formed on an arc-shaped peripheral surface. An escape surface 64 is formed on lower surfaces of base 1 sides of the engaging member 59 and the cutter lever 52 as shown in FIGS. 3 and 4. Further, an escape surface 65 is formed even on a lower surface of a base 1 side of the cutter cover 51 as shown in FIGS. 3 and 4.

In FIG. 4, a narrow width fitting recess 42 extending to the both side ends of the longitudinal direction of the base 1 extends in a straight line on the base 1 which is oppositely disposed to the rotary blade 11, and a slender blade rest pad 43 made of a hard rubber material or the like is fitted into the fitting recess to be supported thereby. A reinforcing material is disposed on a back surface side of the fitting recess 42.

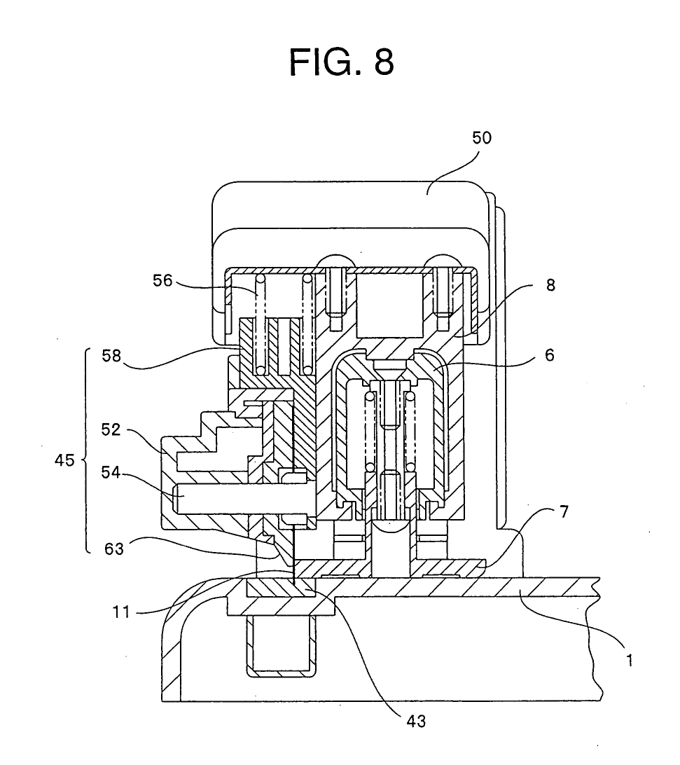

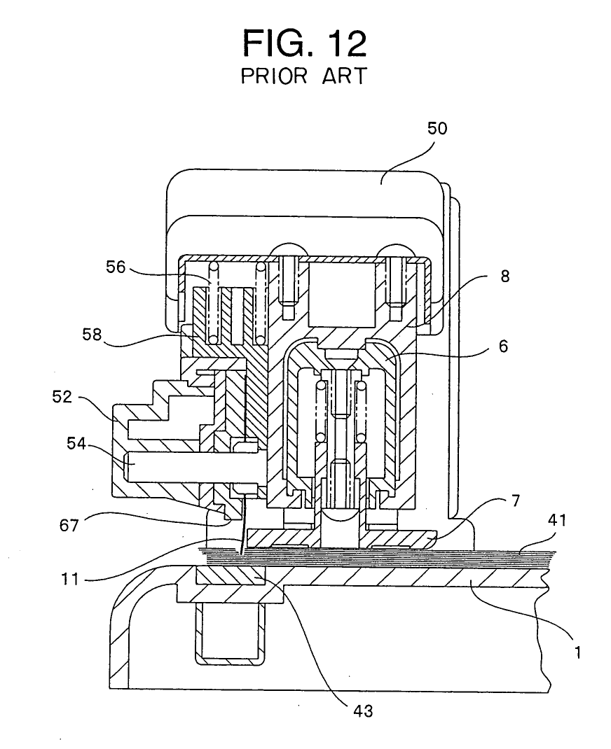

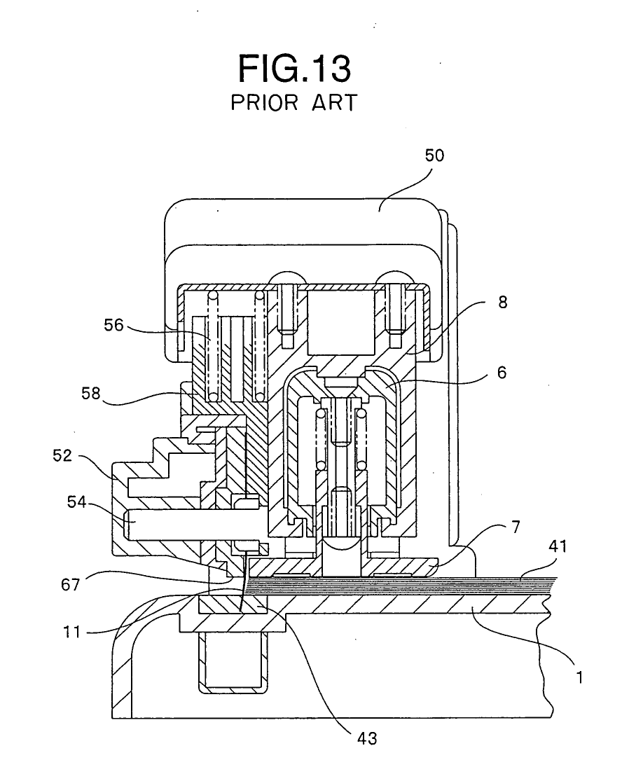

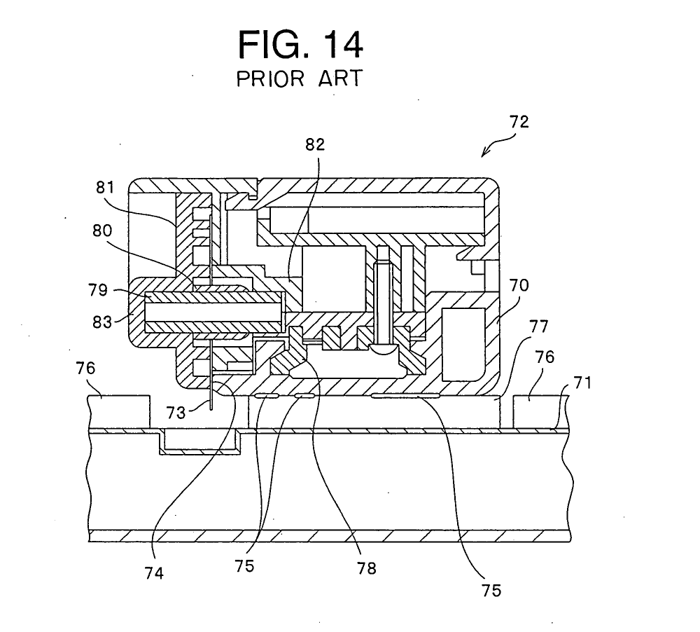

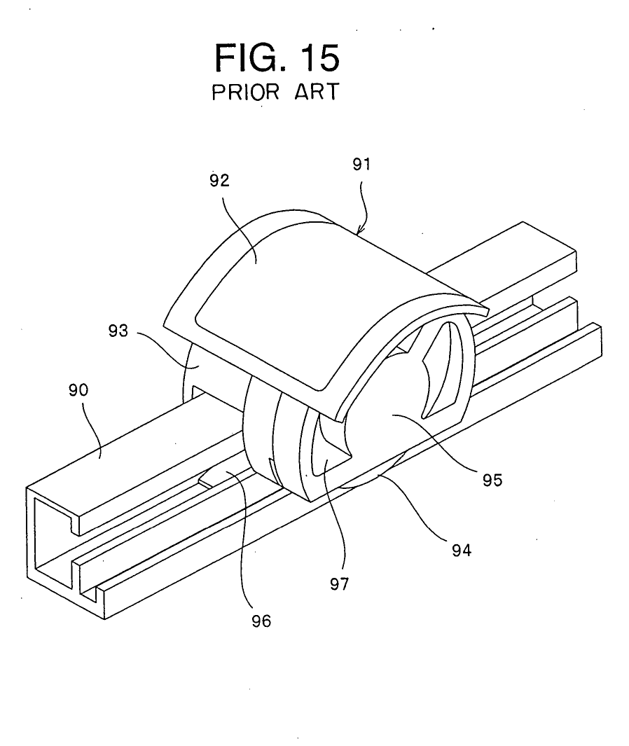

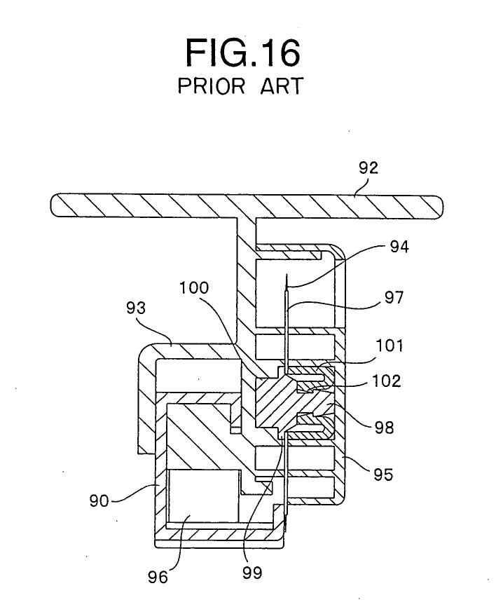

Next, cutting conditions of the rotary blade 11 according to the present invention will be described with reference to FIGS. 8 through 11. In order to describe characteristics of the cutterhead 45 of the present invention, FIGS. 12 and 13 are provided as operational state views of a case where the cutter abutting plate is not employed.

FIG. 8 shows a state where the holding means 4 is stacked on the supporting body 3a as shown in FIG. 1, in which the rail 6 is lowered to the base 1 side, and in which paper to be cut is not inserted between the paper pressing plate 7 and the base 1. At this time, the rotary blade 11 has been inserted onto the blade rest pad 43.

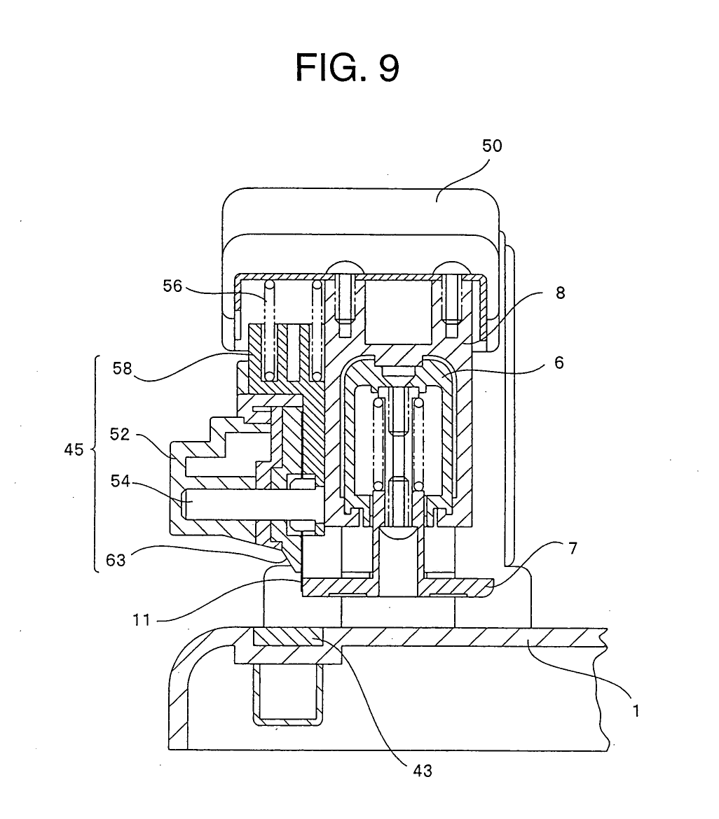

From this state, the holding means 4 is rotated with respect to the supporting body 3a as shown in FIG. 2, and the rail 6 is raised, thereby resulting in the state shown in FIG. 9. At this time, the distal edge of the rotary blade 11 is positioned in a state where the distal edge does not protrude from the bottom surface of the paper pressing plate 7.

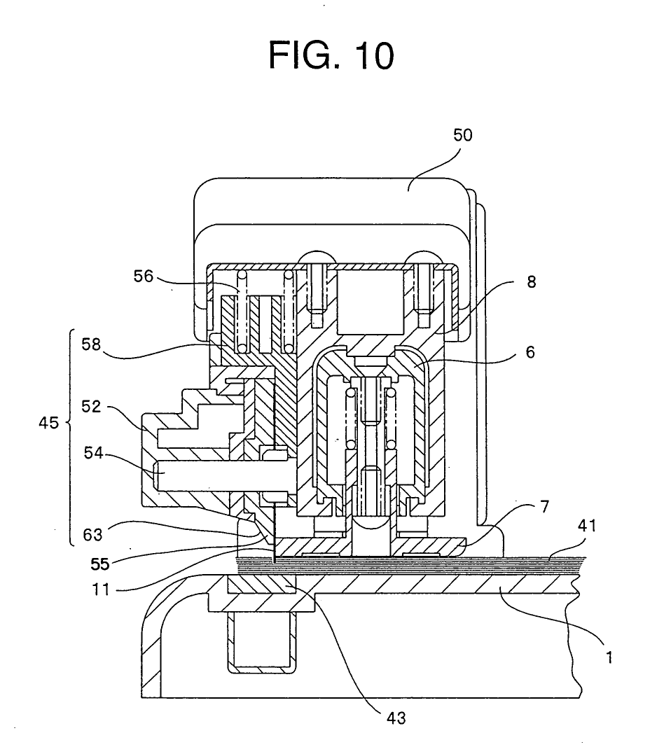

Paper to be cut 41 (see FIG. 10) is inserted into the gap between the paper pressing plate 7 and the base 1, and the holding means 4 is rotated so as to be stacked on the supporting body 3a to allow the rail 6 to be lowered. During the lowering of the rail by the rotation of the holding means 4, the paper pressing plate 7 abuts the upper surface of the paper to be cut 41. As the rail 6 is lowered further, the paper pressing plate 7 presses and holds the paper to be cut 41 while compressing the paper pressing spring 26. At this time, the rotary blade 11 is lowered to a position where the rotary blade 11 does not abut the paper to be cut 41.

After the rotation of the holding means 4 is completed so that the holding means 4 overlaps the supporting body 3a, the lowered position of the rail 6 is held by the parallel guiding surface 17b in the second guiding hole of the interlock member described above.

From this state as the slider 8 is allowed to slide along the rail 6, the distal edge of the rotary blade 11 abuts the paper to be cut 41. At this time the rotary blade 11 rotates to decrease the abutting force and to allow the cutter holder 58 to be raised against the bias force of the cutter spring 56 by this abutting force. By this manner, the rotary blade 11 can cut into the paper to be cut 41 at a predetermined depth. A state where the rotary blade 11 cut into the paper to be cut 41 is shown in FIG. 10.

At this time, the rotary blade 11 is sandwiched between the cutter abutting plate 55 and the side surface of the paper pressing plate 7. Thus, the blade edge of the rotary blade 11 is prevented from bending in a direction that the rotary blade 11 is separated from the side surface of the paper pressing plate 7. As shown in FIG. 12 where the state thereof has become the same as that of FIG. 10, at this time, in a case where the cutter abutting plate supporting the side surface of the rotary blade 11 is not lowered to the position of the side surface of the paper pressing plate 7, as shown in FIG. 12, a gap exists between a bottom surface 67 of the cutter abutting plate and an upper surface of the paper pressing plate 7.

When the gap exists between the bottom surface 67 of the cutter abutting plate and the upper surface of the paper pressing plate 7, the span from the cutter abutting plate to the blade edge of the rotary blade 11 becomes longer so that the rotary blade 11 tends to bend in the direction in which the rotary blade 11 is separated from the paper pressing plate 7. From this state by allowing the slider 8 to slide along the rail 6 to cut the paper to be cut 41 by means of the rotary blade 11, as shown in FIG. 13, a cut surface created by a large number of paper sheets to be cut 41 has a widening shape that widens toward the base 1 side.

Thus, a large number of paper sheets to be cut 41 cannot be cut precisely. On the other hand, in the present invention, as shown in FIG. 8, when cutting is started by means of the rotary blade 11, since both surfaces of the rotary blade 11 can be supported by the cutter abutting plate 55 and the side surface of the paper pressing plate 7, bending of the blade edge of the rotary blade 11 can be prevented.

As the slider 8 is slid to slide along the rail 6 in the state where bending of the blade edge of the rotary blade 11 is prevented, cut pieces by cutting by means of the rotary blade 11 can be removed from the cut position by means of the escape surfaces 63-65. Through one forward going movement along the rail 6 of the slider 8, the rotary blade 11 can cut a certain number of paper sheets to be cut 41. At the time of returning movement of the slider 8 in the next step, the blade edge position of the rotary blade 11 is lowered by the bias force of the cutter spring 56, and while cut pieces being cut previously are removed by means of the escape surfaces 63-65, a certain number of paper sheets to be cut 41 can be cut by means of the rotary blade 11.

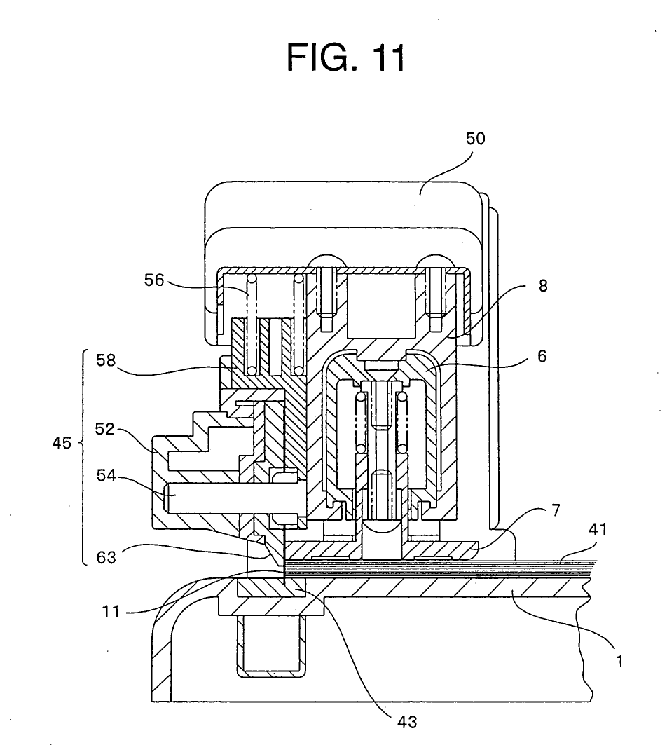

By repeating the reciprocating motion along the rail 6 of the slider 8, paper to be cut can be cut up to the lowest position at a predetermined cutting position by means of the rotary blade 11 as shown in FIG. 11. Further, during cutting of the paper to be cut 41 by means of the rotary blade 11, since the rotary blade 11 can be constantly sandwiched by the cutter abutting plate 55 and the side surface of the paper pressing plate 7, the blade edge of the rotary blade 11 can constantly maintain the direction perpendicular to the base 1.

Furthermore, cut pieces by cutting of one time sliding of the slider 8 can be removed at the time of the next slide of the slider 8 by means of the escape surfaces 63-65 respectively formed on the cutter cover 51, the cutter lever 52, and the cutter abutting plate 55. Thus, a gap can be constantly formed between the bottom surface of the cutter abutting plate 55 and the distal edge of the rotary blade 11, and a situation in which the bottom surface of the cutter abutting plate 55 abuts cut pieces to stop the lowering of the rotary blade 11 does not occur.

What is claimed is:

1. A cutterhead attached to a slider which is slidable along a paper pressing plate in a paper cutter, wherein the cutterhead comprises a cutter abutting plate supporting one side surface of a cutting blade, and that an escape surface for removing cut pieces produced by cutting of paper to be cut from the cutting blade side is formed on at least one part of an end portion in the cutter abutting plate facing a base side of the paper cutter.

2. The cutterhead according to claim 1, wherein at least at a cut-starting time of paper to be cut by means of the cutting blade, the cutting blade is sandwiched by the cutter abutting plate and a side surface of the paper pressing plate.

3. The cutterhead according to claim 1, wherein the cutting blade is a rotary blade, and that the cutterhead rotatably supports the rotary blade.

4. The cutterhead according to claim 2, wherein the cutting blade is a rotary blade, and that the cutterhead rotatably supports the rotary blade.

5. The cutterhead according to claim 1, wherein the cutterhead is attached to the slider through a spring which urges the cutterhead toward the base side of the paper cutter.

6. The cutterhead according to claim 2, wherein the cutterhead is attached to the slider through a spring which urges the cutterhead toward the base side of the paper cutter.

7. The cutterhead according to claim 3, wherein the cutterhead is attached to the slider through a spring which urges the cutterhead toward the base side of the paper cutter.
